(19) United States
(12) Patent Application Publication
(10) Pub. No.: US 2010/0073491 A1
(43) Pub. Date: Mar. 25, 2010

(54) DUAL BUFFER SYSTEM FOR IMAGE PROCESSING

(76) Inventor: Anthony Huggett, Basingstoke (GB)

Correspondence Address: Dickstein Shapiro LLP, 1825 Eye Street, NW, Washington, DC, 20006, US

(21) Appl. No.: 12/234,723

(22) Filed: Sep. 22, 2008

(51) Int. Cl. H04N 5/225

(52) U.S. Cl. 348/207.99; 348/E05.024

(57) ABSTRACT

A processing system has a backlog of data caused by a difference between an input rate for receiving pixel data and a conversion rate for converting the pixel data to new pixel data. A dual buffer system associated with the processing system stores a minimum amount of unprocessed pixel data, required to perform an associated processing operation, in a first memory device and stores a backlog of the processed pixel data, after performing the associated processing operation, in a second memory device. The combined size of the first and second memory devices is less than the size that would otherwise be required to store the minimum amount of pixel data and the backlog of pixel data as unprocessed pixel data.

### TECHNICAL FIELD

Embodiments disclosed herein relate generally to video processing.

### BACKGROUND

Image sensors may write pixel data into a buffer used by a image processor. The rates of outputting pixel data from an image sensor and inputting the pixel data to a buffer are typically fixed and equal (i.e., determined by the characteristics of the system). The rate at which the pixel data can be overwritten in the buffer, without losing the stored pixel data that is still being used for processing, is also typically fixed. When new pixel data is written to the buffer, the memory usage of the buffer increases. When the stored pixel data is no longer needed for processing and therefore can be overwritten without losing needed data, the memory usage of the buffer decreases. The rates of these changes are herein referred to as the input rate and discard rate, respectively.

Processing of pixel data may involve creating each line of output data based on data from multiple lines of the input image. The number of lines of input data from which each line of output data is produced may not be constant from line to line, resulting in a varying discard rate. The buffer must store at least the maximum amount of data used to create any one line of output pixel data. This is referred to as the “fundamental requirement.”

Further buffering may be required due to the timing characteristics of the video standards, or if the input rate exceeds the discard rate due to the nature of the transformation. For instance, with a large fundamental requirement that occurs both at the top and bottom of the image, it may be necessary to begin inputting data for the next frame before the current frame has been completely output. Alternatively, the variable discard rate may be less than the fixed input rate, resulting in a backlog of data which may exceed the size of the fundamental requirement. Any extra buffering beyond the fundamental requirement is referred to as the “timing requirement.” In a hardware application the amount of buffering has a direct area and cost implication. It is therefore desirable to reduce the size of the timing requirement.

### BRIEF DESCRIPTION OF THE DRAWINGS

FIG. 1 is a block diagram of an imaging system.

FIG. 2A is a diagram of a portion of an image processed by a spatial transform operation.

FIG. 2B is a diagram of an image output by the spatial transform operation of FIG. 2A.

FIG. 3 is a block diagram of a processing system.

FIG. 4 is a graph illustrating the effect of timing constraints on the memory usage of the processing system of FIG. 3.

FIG. 5 is a block diagram of a processing system implemented in accordance with an embodiment of the disclosure.

FIG. 6A is a block diagram of the storage and processing of pixel data by the processing system of FIG. 3.

FIG. 6B is a block diagram of the storage and processing of pixel data by the processing system of FIG. 5.

FIG. 7 is a graph illustrating the effect of timing constraints on the memory usage of the processing system of FIG. 5.

### DESCRIPTION OF THE DRAWINGS

The accompanying drawings illustrate specific embodiments of the invention, which are provided to enable those of ordinary skill in the art to make and use them. It should be understood that the claimed invention is not limited to the disclosed embodiments as structural, logical, or procedural changes may be made.

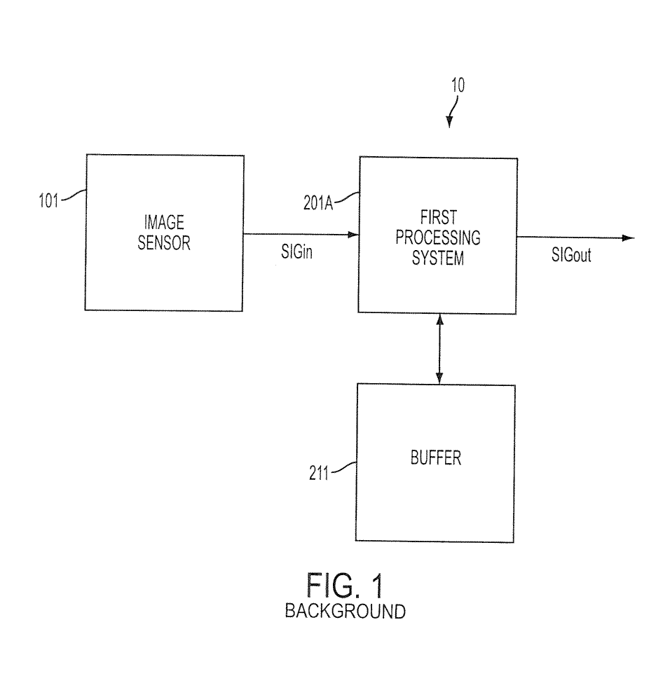

FIG. 1 is a block diagram of a portion of an imaging system 10 and, more particularly, a portion of an image processing chain. The imaging system 10 includes an image sensor 101, a first processing system 201A, and a buffer 211 for storing pixel data used by the illustrated portion of the image processing chain. The first processing system 201A receives pixel data in an input signal SIGin, stores the pixel data in the buffer 211, performs its processing operation, and transmits new pixel data in an output signal SIGout, e.g., a video signal. The first processing system 201A may implement processing operations including but not limited to positional gain adjustment, defect correction, noise reduction, optical cross talk reduction, demosaicing, color filtering, resizing, sharpening, output formatting, compression, and spatial transformation (e.g., image stretching, image dewarping, and image rotation).

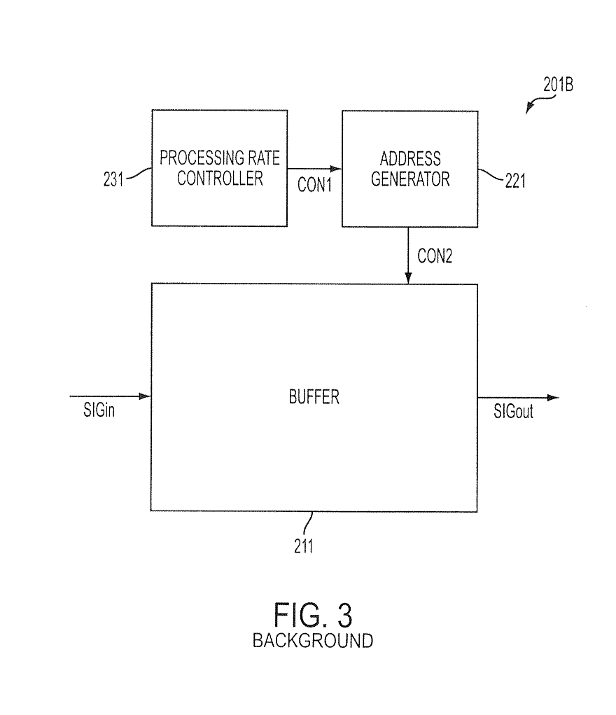

The buffer 211 may also be arranged as part of a processing system and receive the pixel data from input signal SIGin directly from the image sensor 101 (see e.g., the second processing system 201B of FIG. 3). Regardless of its placement, the buffer 211 must be large enough to accommodate both the fundamental requirement of the processing operation and the timing requirement.

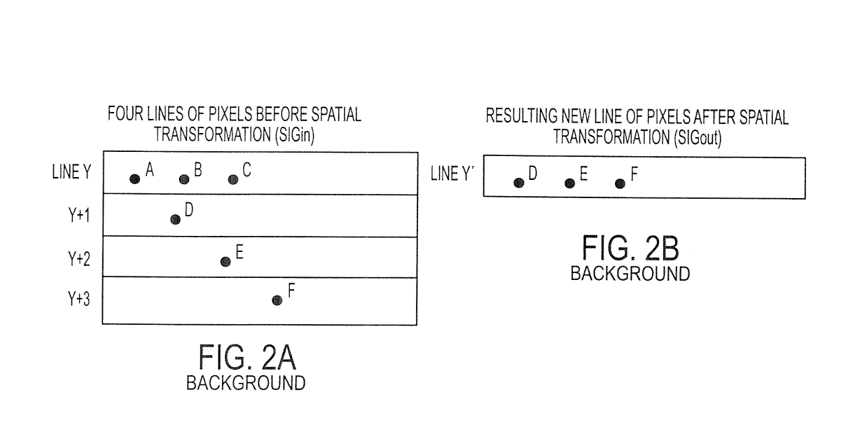

In spatial transformation, the values of pixels from one line of an image are replaced by the values of pixels from other lines of the image, such that a new sequence of pixels is thereby generated to form a new line of an output image (as modified). FIG. 2A illustrates four lines, y, y+1, y+2, y+3, of pixels of an input image before spatial transformation, which also represents the fundamental requirement of pixel data needed to perform the spatial transformation. FIG. 2B illustrates a new line y′ of pixels for the output image produced from the four lines of pixels shown in FIG. 2A. To form line y′, the values of pixels A, B, and C from line y of the input image are replaced with values of pixels D, E, and F, respectively, from lines y+1 to y+3 of the input image. More particularly, the value of pixel A is replaced with the value of pixel D from line y+1; the value of pixel B is replaced with the value of pixel E from line y+2; and the value of pixel C is replaced with the value of pixel F from line y+3. On a greater scale, many pixels of each line of the input image may be replaced, such that the input image is spatially transformed, e.g., dewarped, to form the output image.

FIG. 3 is a block diagram of a second processing system 201B, which may be substituted for the first processing system 201A of FIG. 1. As shown in FIG. 3, the buffer 211 is part of the second processing system 201B and receives the pixel data in an input signal SIGin line-by-line from the image sensor 101 (FIG. 1), such that the pixel data is written to the buffer 211 at least one line at time.

A processing rate controller 231 transmits a first control signal CON1 to an address generator 221, which instructs the address generator 221 when and which pixel of the stored pixel data will be read from the buffer 211 as the next pixel of the new pixel data, i.e., will be read from the buffer 211 as the next pixel of the output signal SIGout. In turn, the address generator 211 outputs a second control signal CON2 to the buffer 211, which instructs the buffer 211 (or, more particularly, instructs an input/output device for reading out data from the buffer 211) to read out a particular pixel of the stored pixel data as the next pixel for the output signal SIGout.

The above process is repeated, pixel-by-pixel, to read out a new line of pixel data. Based on the timing of the first control signal CON1, each line of pixel data can be read out from the buffer 211 in accordance with the timing requirements of the processing system 201B. After a line of pixel data in the buffer 211 is no longer needed, it may be overwritten with another line of pixel data from the image sensor 101. In this manner, pixel data within the buffer 211 is overwritten, line-by-line, when it is no longer needed for generating output pixel data. Because the buffer 211 receives new pixel data from the image sensor 101 (FIG. 1) at a greater fixed rate than the stored pixel data in the buffer 211 can be utilized by the processing system 201B, the size of the buffer 211 must be large enough to accommodate both the fundamental requirement and the “backlog” caused by the difference between the input rate and the discard rate.

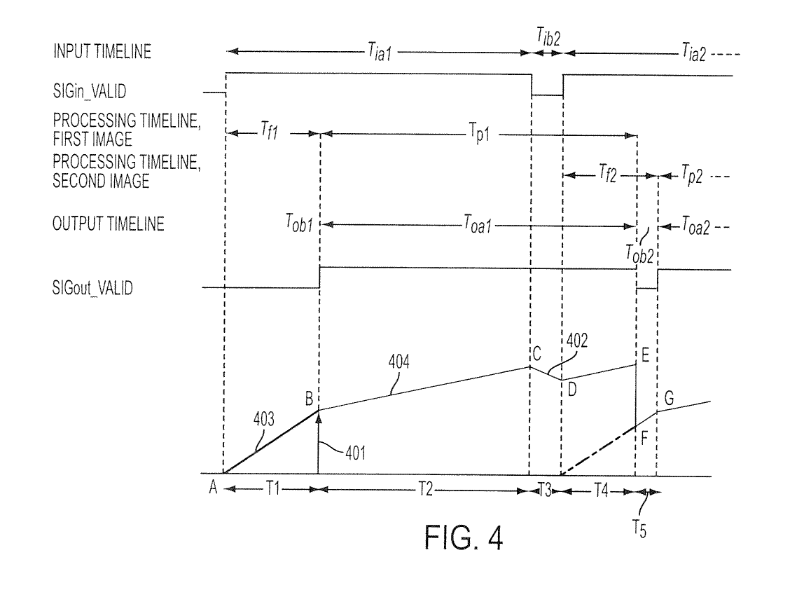

FIG. 4 is a graph of the memory usage (line 404) of the second processing system 201B, which is shown in correlation to the input signal valid SIGin_valid, the output signal valid SIGout_valid and processing timelines of first and second images (e.g., first and second image frames of streamed video). In the graph, the horizontal axis represents time. The vertical axis represents amount of data. Arrow 401 represents the amount of data corresponding to the fundamental requirement. The slope of line 403 from A to B is a fixed input rate at which the pixel data from input signal SIGin is written to the buffer 211 when SIGin_valid is high. The slope of line 402 from C to D is a fixed discard rate according to the conversion rate at which the pixel data stored in buffer 211 is converted into the new pixel data read from the buffer 211 as the output signal SIGout, when SIGout_valid is high. Line 404 from B to G represents the memory usage of the second processing system 201B at a given moment. The highest value of the memory usage, which in FIG. 4 occurs at time E (FIG. 4), determines the required minimum size of the buffer 211.

As shown by the input signal valid SIGin_valid, the pixel data of the entire first image is written to the buffer 211 during a first active period Tia1. No pixel data is input to the buffer during the subsequent vertical blanking period Tib2. The pixel data of the entire second image is written to the buffer 211 during a second active period Tia2 (partially shown). As shown by the processing timeline of the first image and by the output valid signal SIGout_valid, the pixel data of the first output image is not read out until the buffer 211 fills with sufficient pixel data, during time period Tf1, to meet the fundamental requirement (arrow 401). When the fundamental requirement is met at the end of time period TF1, the second processing system 201B starts reading out the output signal SIGout and continues doing so for the duration of time period Tp1.

Pixel data of the second image is written to the buffer 211 while the pixel data of the first image still remains in the buffer 211. Thus, the time period Tf2 (during which the fundamental requirement (line 401) of pixel data of the second image is being stored to the buffer 211) overlaps the time Tp1 (during which the new modified pixel data of the first image is being read out from the buffer 211 as the output signal SIGout). The time period Tp2, which represents the duration of processing for the second image, begins at the end of time period Tf2 when enough lines of the second image pixel data have been written to the buffer 211 to begin processing of the second image. The above operations and their effect on the memory usage (line 404) of the second processing system 201B is now described with reference to time periods T1 to T5.

During time period T1, which spans from time A to time B and corresponds to time Tf1, the buffer 211 fills with pixel data (as indicated by the high input signal SIGin) of the first image, at the input rate (line 403), until the fundamental requirement (line 401) is met. At time B, which corresponds to the end of time Tf1, enough lines of the pixel data of the first image are stored in the buffer 211 to satisfy the fundamental requirement. Consequently, outputting of the new pixel data (as indicated by the high output signal SIGout) of the first image begins at time B.

During time period T2, which spans from B to C, the buffer 211 continues to receive pixel data (as indicated by the high input valid signal SIGin_valid) of the first image at the input rate (which is the slope of line 403, from A to B). The system is outputting data, thus there is a discard rate. In this example, we have assumed that the discard rate from B to E is constant, with a rate shown by the slope of line 402 from C to D. Because the input rate is greater than the discard rate, the memory usage increases at a rate equal to the difference between the input rate and discard rate, as shown by the slope of input rate, which allows some more space in the buffer, thus buffer continues to fill, but at a slower rate equal to the difference of the input rate and the discard rate, until it reaches a peak at point C, as shown by the slope of the memory usage line 404 from B to C.

At time C, the entire first image of pixel data has been received by the buffer 211. Thus, during time period T3, which spans from time C to time D, the buffer 211 has stopped receiving pixel data (as indicated by the low input valid signal SIGin_valid) of the first image. However, the new pixel data of the first image continues to be read out from the buffer 211 as output signal SIGout (as indicated by the high output valid signal SIGout_valid). Consequently, the memory usage (line 404) of the second processing system 201B decreases at the conversion rate (line 402) from time C to time D.

At time D, while still reading out the pixel data of the first image (as indicated by the high output valid signal SIGout_valid), the buffer 211 begins to receive pixel data of the second image (as indicated by the high input valid signal SIGin_valid). Therefore, during time period T4, which spans from time D to time E, pixel data of the first image is being read out from the buffer 211 (as indicated by the high output valid signal SIGout_valid) while pixel data of the second image is being input to the buffer 211 (as indicated by the high input valid signal SIGin_valid) at the input rate (line 403). As a result, the memory usage (line 404) again increases at a rate equal to the difference between the input rate (line 403) and discard rate (line 402).

At time E, the new pixel data of the first image has been completely read out from the buffer 211 (as indicated by the low output valid signal SIGout_valid) while pixel data of the second image continues to be input (as indicated by the high input valid signal SIGin_valid). Consequently, the pixel data of the first image that remains stored within the buffer 211, which is an amount of data equal to the fundamental requirement (line 401), is no longer needed and is therefore immediately available for overwriting by the pixel data of the second image. Thus, the memory usage (line 404) of the second processing system 201B precipitously drops at time E to the amount of pixel data of the second image stored in the buffer 211 at that time.

As noted, the minimum size of the buffer 211 is equal to the highest memory usage (line 404), which may occur at time C or time E depending on the particular implementation. Because the memory usage rises at a rate determined by the sum of the input rate (line 403) and discard rate (line 402), the minimum size of the buffer 211 may be reduced by decreasing the fixed input rate or by increasing the fixed discard rate. However, an increase in the discard rate may be unobtainable, e.g., due to standard industry constraints on the frequency rate of the output signal SIGout. A decrease of the fixed input rate may also be unobtainable, e.g., the input rate is dictated by a desired length of time for outputting an image from the image sensor 101.

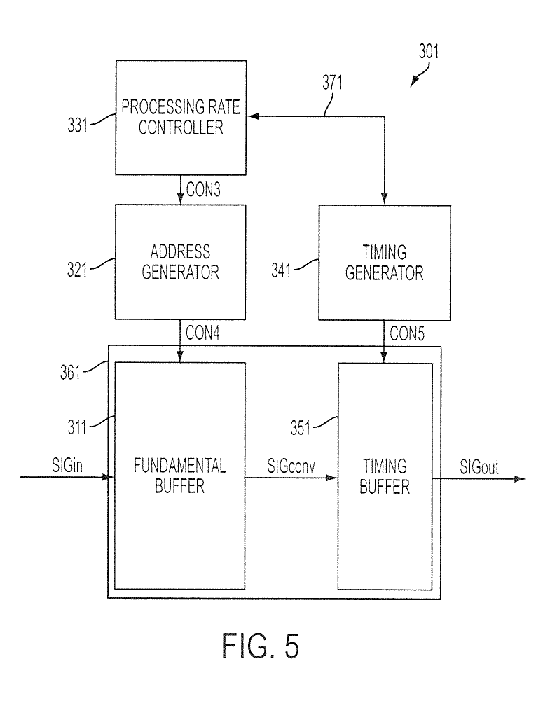

FIG. 5 is a block diagram of a third processing system 301, which describes a buffer system that is advantageous when the size of the output image is smaller than the input image. This is commonly the case due to progressive to interlace conversion, reduced bit precision, or smaller output picture format. Like the second processing system 201B of FIG. 3, the third processing system 301 may be substituted for first processing system 201A of FIG. 1, such that the imaging system 10 employs the third processing system 301 in lieu of the first processing system 201A.

The third processing system 301 is analogous to first and second processing systems 101, 201, with SIGin and SIGout having rates constrained as before, and performs an operation with the same fundamental requirements. Within the buffer 361, the fundamental buffer 311 has been split from the timing buffer 351, and these are controlled by separate signals CON4 and CON5. The input image is received line-by-line by a fundamental buffer 311. The conversion rate of SIGconv is variable, controlled by CON4, such that the discard rate prevents a backlog of data accumulating in the fundamental buffer 311. Instead, this backlog is passed into Timing Buffer 351.

A processing rate controller 331, address generator 321, and the fundamental buffer 311 of FIG. 5 operate similarly to the processing rate controller 231, address generator 221, and buffer 211 of FIG. 3. The processing rate controller 331 transmits a third control signal CON3 to the address generator 321, which instructs the address generator 321 when and which next pixel of the stored pixel data (within the fundamental buffer 311) should be read out from the fundamental buffer 311 to the timing buffer 351 (which may be a line buffer). In turn, the address generator 321 outputs a fourth control signal CON4 to the fundamental buffer 311, which instructs the fundamental buffer 311 (or, more particularly, instructs an input/output device associated with the fundamental buffer 311) to read out the next pixel. In the above manner, the pixels forming the new image are written, line-by-line into the timing buffer 351 (which may be a simple FIFO, further reducing the size requirement).

The buffer 211 of FIG. 3 is larger than the fundamental buffer 311 of FIG. 5, which is sized to hold only (or slightly more than) the fundamental requirement of pixel data. In fact, the buffer 211 of FIG. 3 is larger than the combined size of the fundamental buffer 311 and timing buffer 351 of FIG. 5, i.e., larger than the size of the entire buffer system 361. The buffer 211 of FIG. 3 is larger than the buffer system 361 of FIG. 5 because, although both must hold the same fundamental requirement of pixel data, the backlog of pixel data is stored by the buffer 211 of FIG. 3 before producing the output data in a smaller format. On the other hand, the same backlog of pixel data is stored by the buffer system 361 of FIG. 5 in the timing buffer 351, having first undergone the conversion to the smaller format of the output signal. Thus, the extra size imposed by the timing requirement upon the buffer 211 of FIG. 3 is larger than the timing buffer 351 within the buffer system 361 of FIG. 5.

The rate at which the pixel data is input to the timing buffer 351 is controlled by the processing rate controller 331 (as described above), which more particularly controls the rate at which the pixel data is read out from the fundamental buffer 311. The rate at which the pixel data is read out from the timing buffer 351 is controlled by the timing generator 341, which transmits a fifth control signal CON5 instructing the timing buffer 351 (or, more particularly, instructs an input/output device associated with the timing buffer 351) when and which pixels to read out as a line of pixel data carried by the output signal SIGout.

The conversion rate of the fundamental buffer 311 is maintained low enough to prevent overwriting of needed pixel data within the timing buffer 351, whilst being fast enough that the discard rate prevents a backlog of unprocessed data in the input buffer 311 above the fundamental requirement. The rates at which the pixel data is read out from the fundamental buffer 311 and the timing buffer 351 may be coordinated to prevent the overwriting of pixel data in the timing buffer 351 that has yet to be output by the third processing system 301. Such coordination may be achieved, for example, by communication between the processing rate controller 331 and timing generator 341; or, for example, by a shared lookup table correlating the respective readout rates of the fundamental buffer 311 and timing buffer 351. A signal line 371 used for communication between the processing rate controller 331 and timing generator 341 is shown in FIG. 5. Thus, the processing rate controls of the third processing system 301, as determined by the collective operation of the processing rate controller 331 and timing generator 341, may be static, determined by an external agent (e.g., a look up table), or dynamic (e.g., such that the processing rate controller 331 receives a signal, via signal line 371, from the timing generator 341).

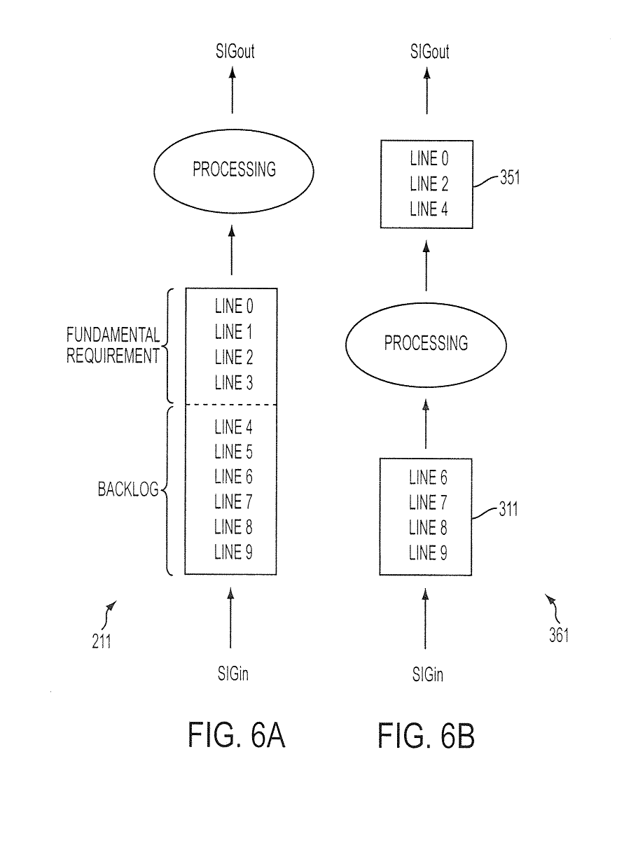

FIGS. 6A and 6B are diagrams illustrating the processing and movement of pixel data by the second and third processing systems 201B (FIG. 3), 301 (FIG. 5). It is assumed here that the output is interlaced, and thus, only alternate lines of output are produced. As shown in FIG. 6A, in the second processing system 201B, the buffer 211 stores the pixel data line-by-line (e.g., lines 0-9). The fundamental requirement is represented by the four lines of pixel data arranged over the dotted line (e.g., lines 0-3). The backlog of data is represented by the six lines of pixel data below the dotted line (e.g., lines 4-9). Thus, as shown, buffer 211 stores both the fundamental requirement and the backlogged data as unprocessed pixel data. During the processing operation, e.g., for forming the even field of a spatially transformed image, the earliest received four lines of pixel data (e.g., lines 0-3) are used to output a corresponding line of pixel data (e.g., line 0). In this example, lines 0-3 of the stored pixel data are used to output line 0 of the pixel data; then lines 2-5 of the stored pixel data are used to output line 2 of the pixel data; and so forth.

As shown in FIG. 6B, in the third processing system 301 the buffer system 361 stores the fundamental requirement of pixel data within fundamental buffer 311 (e.g., lines 6-9). During processing, e.g., for forming the even field of a spatially transformed image, the four lines of pixel data (e.g., lines 0-3) within the fundamental buffer 311 are used to read out a corresponding line of pixel data (e.g., line 0) to the timing buffer 351. In this example, lines 0-3 of the stored pixel data are used to read out line 0 of the pixel data; lines 2-5 of the stored pixel data are used to read out line 2 of the pixel data; and lines 4-7 of the stored pixel data are used to read out line 4 of the pixel data. Thus, the backlogged data is stored as lines 0, 2, and 4 of the even field within the timing buffer 351 in lieu of storing the backlogged data as lines 0-5 of the full format image.

As shown above, the total buffer requirements of the second and third processing systems 201B, 301 result from a fundamental requirement imposed by spatial considerations of the processing operation, and a timing requirement imposed by constraints on the video input and output formats. Unlike the processing system of 201B of FIG. 3, the processing system 301 of FIG. 5 reduces the timing requirement by utilizing a dual buffer system 361, which stores the incoming image (pixel data from input signal SIGin) to meet the spatial requirement and stores the outgoing image (pixel data which will become the output signal SIGout) in a smaller format to meet the timing requirement.

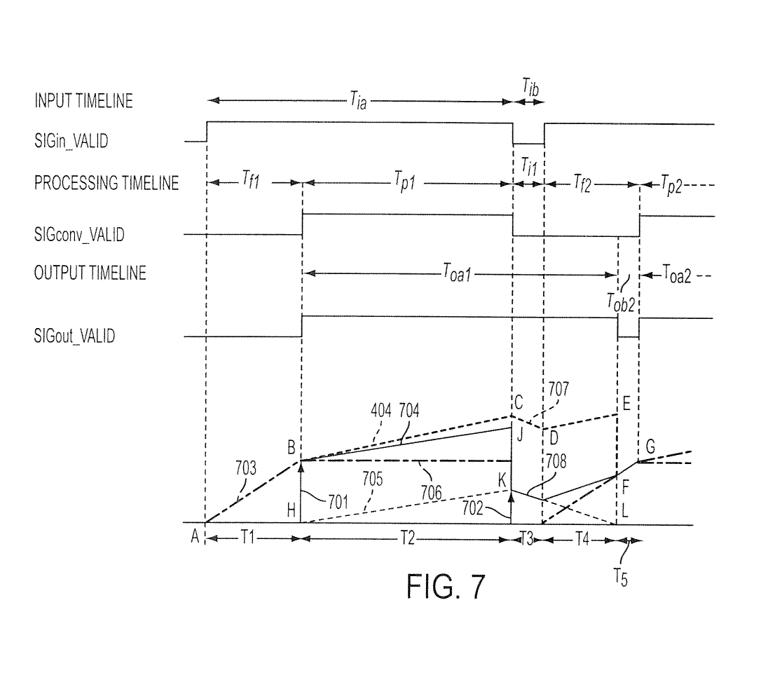

FIG. 7 illustrates memory usage (line 704) of the third processing system 301 versus time, correlated to input, processing and output timelines, for an example spatial transformation. In the graph, the horizontal axis represents time. The vertical axis represents amount of data. The dot-dash line 706 represents the amount of data in the fundamental buffer 311 at a particular point in time. The dotted line 705 represents the amount of data in the timing buffer 351 at a particular point in time. The total memory used by the third processing system 301 is shown by the solid line 704 from B to G. The dashed line 404 from B to G is the memory requirement of the second processing system 201, for comparison.

The example spatial transformation used requires the fundamental requirement of data to be present in the fundamental buffer 311 for creating the first line of the output image, and for creating the last line of the output image. It is assumed that creating each and every line of the output image data uses the same amount of input data; i.e., the discard rate is constant with the processing rate.

As collectively indicated by the processing timeline of the first image and the output valid signal SiGout_valid, the output of pixel data of the first image does not commence until the fundamental buffer 311 fills with sufficient pixel data, during time period Tf1, to meet the fundamental requirement (line 701). After the fundamental requirement is met at the end of time period Tf1, the new pixel data of the first image is read out from the fundamental buffer 311 to the timing buffer 351. This processing of the first image continues for the duration of time period Tp1. Time period Tf2 (during which the fundamental requirement of pixel data of the second image is being stored to the fundamental buffer 311) does not overlap time period Tp1. Time period Tp2, which represents the duration for processing the new pixel data of the second image, begins at the end of time period Tf2 when enough lines of pixel data of the second image have to been written to the fundamental buffer 311 to begin the processing operation. Time period Toa1 is the time interval during which the output is active, i.e., data of the first image is being output from the timing buffer 351; similarly, time period Toa2 is the output active period for the second image.

The memory usage (lines 404, 704) of the second and third processing systems 201B, 301 are identical during time period T1, which spans from time A (FIG. 7) to time B (FIG. 7) and corresponds to time Tf1. During this time, the fundamental buffer 311 fills with pixel data (as indicated by the high input valid signal SIGin_valid) of the first image at the input rate (the slope of line 703) until the fundamental requirement (arrow 701) is met. At time B (FIG. 7), which corresponds to the end of time period Tf1, enough lines of the pixel data of the first image are stored in the fundamental buffer 311 to satisfy the fundamental requirement. Consequently, at time B (FIG. 7), lines of pixel data are read out from the fundamental buffer 311 to the timing buffer 351, which in turn begins reading out the lines of new pixel data from the third processing system 301 (as indicated by the high output signal SIGout_valid). Thus, at time B (FIG. 7), pixel data of the first image continues to be written to the fundamental buffer 311 at the input rate (line 703).

During time period T2, which spans from time B (FIG. 7) to time C (FIG. 7), a backlog of pixel data begins to accrue within the buffer system 361 in accordance with the difference between the input rate (slope of line 703) and discard rate (slope of line 707). The buffer system 361 continues to receive pixel data of the first image (as indicated by the high input signal SIGin_valid) at the input rate (slope of line 703). To avoid increasing the amount of data in the fundamental buffer 311, (dot-dash line 706), the processing rate is maintained so as to keep the discard rate equal to the input rate.

The processing rate is faster than the required output rate. This causes a backlog of data to build up in the timing buffer 351, as shown by line 705. Because the format of the data storage in the timing buffer 351 is smaller than the format of the data storage in the fundamental buffer 311 (half size in this example), the rate of memory increase (slope of line 705), is less than the discard rate (which is being controlled to be equal to the input rate). FIG. 7 illustrates that SIGconv_valid is high during time Tp1.

At time C (FIG. 7), the entire first image of pixel data has been received by the fundamental buffer 311, and all the data required for the first output image has been processed into the timing buffer 351. Therefore, at time C, all data in the input buffer is discarded. The timing buffer 351 has reached peak fullness. The required size of the timing buffer 351 is shown by arrow 702. FIG. 7 illustrates that SIGconv_valid is low starting at time C.

During time period T3, which spans from time C (FIG. 7) to time D (FIG. 7), the fundamental buffer 311 is empty and idle. However, the output is still active, thus the timing buffer 351 empties (line 708).

At time D (FIG. 7), while still reading out new pixel data of the first image (as indicated by the high output signal SIGout_valid), the buffer system 361 begins to receive pixel data of the second image (as indicated by the high input signal SIGin_valid). Therefore, during time period T4, which spans from time D (FIG. 7) to time E (FIG. 7), new pixel data of the first image is being read out from the timing buffer 351 (as indicated by the high output signal SIGout_valid) while pixel data of the second image is being input to the fundamental buffer 311 (as indicated by the high input valid signal SIGin_valid). As a result, the total memory usage (line 704) increases, as the fundamental buffer 311 fills and the timing buffer empties 351.

At time F (FIG. 7), all new pixel data of the first image has been read out from the buffer system 361 (as indicated by the low output valid signal SIGout_valid). The state of the buffer system 361 during time interval T4 is now identical to the corresponding end part of interval of T1, with the timing buffer 351 empty and the fundamental buffer 311 filling.

The total buffer requirement of the system 361 is shown by solid line 704. Note that the maximum occurs at time C, and that this is less than the total required by the second processing system 201.

The example illustrated in FIG. 7 uses a discard rate from the fundamental buffer 311 that is constant with the rate of processing (that is the rate of creation of output data into the timing buffer 351). This example shows a relatively small improvement in the buffering requirement. In general, however, the discard rate may vary non-linearly with the processing rate, and hence may show a much greater improvement in the total buffering requirement.

It should be appreciated that invention processes data between a larger format buffer and a smaller format buffer at a varying rate depending on the spatial requirements of the image processing being performed, so as not to increase the amount of buffering required in the larger storage format, putting the overflowing data from said varying rate when compared with a constant output rate into a second buffer with a smaller format, thereby reducing the overall size of the buffering. It should also be appreciated that replacing a first pixel with a second pixel from a different position may include the case when said second pixel is itself interpolated according to known methods from stored pixels near the aforesaid different position if the different position has sub-pixel accuracy.

In addition to the saving from the output format being smaller than the input format, further savings in silicon area from the embodiments of the invention may be realized if the timing and fundamental buffers are physically not part of the same memory, since the timing buffer need only have a simple first-in first-out structure, whereas the fundamental buffer must have at least a random access read port.

It should be understood that though various embodiments have been discussed and illustrated, the claimed invention is not limited to the disclosed embodiments. Various changes can be made thereto.

What is claimed as new and desired to be protected by Letters Patent of the United States is:

1. An image processing system for performing a processing operation, said processing system comprising:
a first buffer configured to store lines of an image having a first format, said lines of said first format image being input at an input rate;
a second buffer configured to store lines of said image having a second format, said first format image comprising a smaller amount of data than said second format image, said lines of said second format image being read out at an output rate,
wherein a capacity of said first buffer is based on a number of lines of said first format image used by said image processing system to generate a respective line of said second format image.

2. The processing system of claim 1, wherein the capacity of said first buffer is substantially equal to a minimum number of lines of said first format image needed by said image processing system to generate said respective line of said second format image.

3. The processing system of claim 1, wherein said lines of said second format image are modified lines of said first format image.

4. The processing system of claim 3, wherein said modified lines of said second format image are generated by substituting pixels of more than one of said lines of said first format image for pixels of one of said lines of said first format image.

5. The processing system of claim 1, wherein a capacity of said second buffer is based on a difference between said input rate and said output rate.

6. The processing system of claim 5, wherein a capacity of said second buffer is based on a difference between a number of lines comprising said first format image and a number of lines comprising said second format image.

7. The processing system of claim 5, wherein said lines of said second format image are read out of said first buffer.

8. The processing system of claim 5, further comprising:
a processing control circuit for controlling a readout rate of said first buffer based at least on a readout rate of said second buffer.

9. The processing system of claim 5, wherein said first buffer is a line buffer which overwrites said lines of said first format image on a first-stored basis, such that earlier stored lines of said first buffer are overwritten before later stored lines of said first buffer are overwritten.

10. The processing system of claim 9, wherein said second buffer is a line buffer which overwrites said lines of said second format image on said first-stored basis, such that earlier stored lines of said second buffer are overwritten before later stored lines of said second buffer.

11. The processing system of claim 10, wherein said lines of said first format image are written directly from said first buffer to said second buffer.

12. The processing system of claim 5, wherein said input rate is greater than said output rate.

13. The processing system of claim 5, wherein said first format image is a full image of a video frame and said second format image is an odd or even field of said video frame.

14. A method of performing an image processing operation, said method comprising:
inputting first lines of pixel data into a processing system at a fixed input rate, said first lines of pixel data forming a portion of an image in a first format;
storing said first lines of pixel data in a first memory device;
processing said first lines of pixel data in said processing system to form second lines of pixel data, said second lines of pixel data forming a portion of said image in a second format;
storing said second lines of said image in a second memory device; and
reading out said second lines of said image from said processing system at a fixed output rate,
wherein said first format image comprises a first amount of data, said second format image comprises a second amount of data less than said first amount of data, and
a size of said second memory device is based on a difference between said input rate and output rate and based on a difference between said first amount of data and said second amount of data.

15. The method of claim 14, wherein each of said second lines of pixel data is based on processing a number of said first lines of pixel data, wherein said number greater than one, and
a size of said first memory device is based on said number of first lines of pixel data.

16. The method of claim 15, wherein said first memory device stores an amount of data substantially equal to said number of first lines of pixel data.

17. The method of claim 14, wherein an amount of memory used by said processing system increases at a rate substantially equal to A×B, where A is equal to said second amount of data divided by said first amount of data and B is equal to the difference between said fixed input rate and said fixed output rate.

18. The method of claim 14, wherein said first format is a full image of a video frame and said second format is an odd or even field of said video frame.

19. The method of claim 15, wherein an amount of memory used by said processing system increases at a rate based on a difference between said input rate and said output rate, and a size of said second memory device is substantially equal to a maximum amount of said memory used minus said number of first lines of pixel data.

20. The method of claim 14, wherein a size of said second memory device is based on a ratio of said first amount of data and said second amount of data.

21. An imager comprising:
an image sensor comprising pixel cells configured to output pixel data representing an image detected by said pixel cells;
a processing system configured to convert first lines of pixel data forming an image in a first format to second lines of data forming said image in a second format, said processing system using a number X of said first lines to generate a number Y of said second lines, X and Y being integers where X is greater than Y, said image in said first format comprising a greater amount of data than said image in said second format; and
a storage device system comprising
a first storage device configured to store said first lines and having a capacity substantially equal said number X of said first lines, and
a second storage device configured to store said second lines and having a capacity based on a fixed conversion rate for converting said number X of said first lines to said number Y of said second lines,
wherein said processing system both receives said lines of said data in said first format and generates said lines of data in said second format for a time period T, and a capacity of said second storage device is substantially equal to a difference between said number X of lines of data in said first format and a maximum number of lines of data in said second format stored by said storage device system at the end of time period T.

22. The imager of claim 21 wherein said capacity of said second storage device is based on a rate of inputting said first lines into said first storage device and a rate of converting said first lines to said second lines.

23. The imager of claim 21, wherein said first lines are directly written from said first storage device to said second storage device.

24. The imager of claim 23, further comprising:
a processing control circuit for controlling a readout rate of said first storage device based on a readout rate of said second storage device.

25. The imager of claim 24, wherein said first lines form part of a full scan image of a video frame and said second lines form part of an odd or even field of an interlaced image.
